(19) United States
(12) Patent Application Publication
(10) Pub. No.: US 2014/0320091 A1
(43) Pub. Date: Oct. 30, 2014

(54) CONTROL METHOD FOR SUPPLYING POWER

(71) Applicant: Nien-Hui Kung, Hsinchu (TW)

(72) Inventor: Nien-Hui Kung, Hsinchu (TW)

(73) Assignee: RICHTEK TECHNOLOGY CORPORATION, Chupei City (TW)

(21) Appl. No.: 14/258,048

(22) Filed: Apr. 22, 2014

Related U.S. Application Data
(60) Provisional application No. 61/816,495, filed on Apr. 26, 2013.

(51) Int. Cl. H02J 7/04; H02M 7/04

(52) U.S. Cl. CPC H02J 7/04; H02M 7/04; H02J 7/022
USPC 320/162; 363/84

(57) ABSTRACT

In a control method for supplying power, a first power regulator supplies a first current and an output voltage to a second power regulator and the second power regulator supplies a second current to a load. The method includes: increasing the output voltage and detecting the second current; determining whether the second current suddenly drops as the output voltage increases; when the second current drops, defining a level of the output voltage which corresponds to a starting point of the sudden drop as an upper limit; when the output voltage increases but the second current neither increases nor suddenly drops, defining a level of the output voltage corresponding to a point where the second current stops increasing as a lower limit; and setting the output voltage to be lower than or equal to the upper limit, and higher than or equal to the lower limit.

### CROSS REFERENCE

The present invention claims priority to U.S. 61/816,495, filed on Apr. 26, 2013.

### BACKGROUND OF THE INVENTION

1. Field of Invention

The present invention relates to a control method for supplying power; particularly, it relates to such a control method capable of achieving efficient power management.

2. Description of Related Art

Please refer to FIG. 1, which shows a block diagram illustrating a hardware configuration where a conventional control method for supplying power is applied to. The hardware configuration 10 comprises a power adaptor 11, a power regulator 12 and a load 13. The load 13 can be, for example but not limited to, a circuit or a battery in an electronic apparatus. An external power source supplies power to the circuit or the battery in the electronic apparatus through the power adaptor 11 and the power regulator 12. The external power source can be, for example but not limited to, a public AC (alternating current) power supplied from a socket on a wall. And, correspondingly, the power adaptor 11 can be, for example but not limited to, an adaptor having a plug. When the external power source is coupled to the power adaptor 11 (i.e., when the plug is in the socket), the power adaptor 11 accordingly receives an AC voltage and current from the external power source and outputs a DC (direct current) voltage and current. The power regulator 12 converts the DC voltage and current to a voltage and a current suitable for the circuit or the battery in the electronic apparatus.

In the hardware configuration 10, the power regulator 12 is coupled between the power adaptor 11 and the load 13. Because there are different specifications of the output voltage and maximum output current of different power adaptor 11 and there are also different specifications of the input voltage and the input current that are required by the input of the load 13, when the power regulator 12 operates for power conversion, an efficient and optimal power management is to match the power supply capability of the power adaptor 11 with the requirement of the load 13. For example, assuming that the power adaptor 11 can supply a larger output current and the load 13 can receive a larger input current, if the power regulator 12 simply delivers a small amount of current to the load 13 (i.e., without efficient utilization of power supplied from the power adaptor 11), the load 13 can not be charged rapidly in a short period. However, assuming that the power adaptor 11 can supply a larger output current but the load 13 can not receive a larger input current, if the power regulator 12 delivers a larger amount of current to the load 13, it would damage the load 13 (or, it would initiate a protection mechanism, thus causing the load 13 to be unable to be charged). The prior art fails to propose an effective automatic management method to deal with different matching situations. Instead, in the prior art, a user has to choose a suitable power adaptor 11 for a corresponding load 13, wherein the chosen power adaptor 11 can only supply a fixed output voltage. However, there may be variations during manufacturing the power adaptor 11 and the load 13 and the performance of the load 13 may be degraded during its lifetime, a manual choice may not be optimal for best utilization of power.

A patent pertinent to the present invention is US Publication No. 2012/0217935.

In view of the above, to overcome the drawback in the prior art, the present invention proposes a control method for supplying power which is capable of achieving efficient power management in the above-mentioned hardware configuration according to different matching situations between the power adaptor 11 and the load 13.

### SUMMARY OF THE INVENTION

From one perspective, the present invention provides a control method for supplying power to an electronic system through a first power regulator, wherein the first power regulator supplies a first current and an output voltage to the electronic system and the electronic system includes a second power regulator and a load, the second power regulator being coupled between the first power regulator and the load, and the second power regulator receiving the first current and supplying a second current to the load; the control method for supplying power comprising the steps of: increasing the output voltage and detecting the second current; determining whether the second current suddenly drops as the output voltage increases; when the second current suddenly drops, defining a level of the output voltage which corresponds to a starting point of the sudden drop of the second current as a first upper limit; and setting the output voltage to be lower than or equal to the first upper limit.

In one embodiment, the control method for supplying power further comprises: when the output voltage increases but the second current neither increases nor suddenly drops, defining a level of the output voltage which corresponds to a point where the second current stops increasing as a first lower limit; and setting the output voltage to be lower than or equal to the first upper limit, and higher than or equal to the first lower limit.

In one embodiment, the control method for supplying power further comprises: when the second current increases as the output voltage increases, keeping increasing the output voltage.

In one embodiment, the control method for supplying power further comprises: increasing the output voltage and detecting the first current; determining whether the first current suddenly drops as the output voltage increases; when the first current suddenly drops, defining a level of the output voltage which corresponds to a starting point of the sudden drop of the first current as a second upper limit; and setting the output voltage to be lower than or equal to a lower one of the first upper limit and the second upper limit.

In one embodiment, the control method for supplying power further comprises: when the output voltage increases but the first current neither increases nor suddenly drops, defining a level of the output voltage which corresponds to a point where the first current stops increasing as a lower limit; and setting the output voltage to be lower than or equal to the lower one of the first upper limit and the second upper limit, and higher than or equal to the lower limit.

In one embodiment, the control method for supplying power further comprises: increasing the output voltage and detecting the first current; determining whether the first current suddenly drops as the output voltage increases; when the first current suddenly drops, defining a level of the output voltage which corresponds to a starting point of the sudden drop of the first current as a second upper limit; and setting the output voltage to be lower than or equal to a lower one of the first upper limit and the second upper limit, and higher than or equal to the first lower limit.

In one embodiment, the control method for supplying power further comprises: when the output voltage increases but the first current neither increases nor suddenly drops, defining a level of the output voltage which corresponds to a point where the first current stops increasing as a second lower limit; and setting the output voltage to be lower than or equal to the lower one of the first upper limit and the second upper limit, and higher than or equal to a higher one of the first lower limit and the second lower limit.

From another perspective, the present invention provides a control method for supplying power to an electronic system through a first power regulator, wherein the first power regulator supplies a first current and an output voltage to the electronic system and the electronic system includes a second power regulator and a load, the second power regulator being coupled between the first power regulator and the load, and the second power regulator receiving the first current and supplying a second current to the load; the control method for supplying power comprising the steps of: increasing the output voltage and detecting the first current; determining whether the first current suddenly drops as the output voltage increases; when the first current suddenly drops, defining a level of the output voltage which corresponds to a starting point of the sudden drop of the first current as an upper limit; and setting the output voltage to be lower than or equal to the upper limit.

In one embodiment, the control method for supplying power further comprises: when the output voltage increases but the first current neither increases nor suddenly drops, defining a level of the output voltage which corresponds to a point where the first current stops increasing as a lower limit; and setting the output voltage to be lower than or equal to the upper limit, and higher than or equal to the lower limit.

In one embodiment, the first power regulator is an AC/DC adaptor and the load is a rechargeable battery.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a block diagram, illustrating a hardware configuration where a conventional control method for supplying power is applied to.

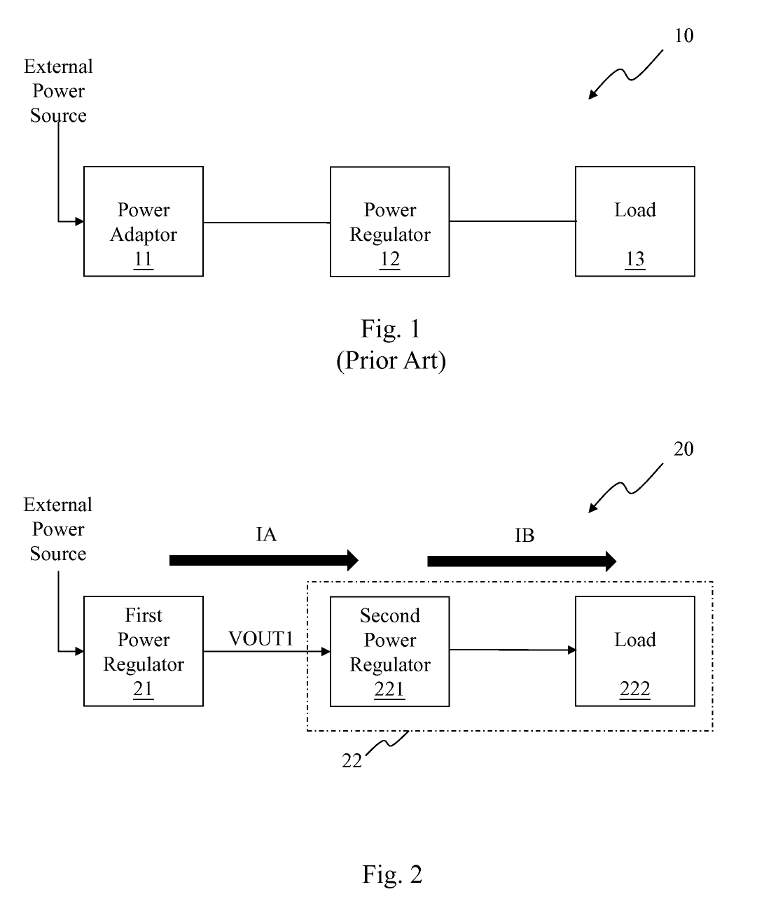

FIG. 2 shows a block diagram, illustrating an embodiment of a hardware configuration where a control method for supplying power according to the present invention can be applied to.

FIG. 3 shows a flowchart, illustrating an embodiment of the control method for supplying power according to the present invention.

FIG. 4 shows a flowchart, illustrating another embodiment of the control method for supplying power according to the present invention.

FIGS. 5A-5D show, according to the control method for supplying power shown in FIG. 3, diagrams illustrating relationships between the second current IB and the output voltage VOUT1.

FIGS. 6A-6B show, according to the control method for supplying power shown in FIG. 4, diagrams illustrating relationships between the first current IA and the output voltage VOUT1.

### DESCRIPTION OF THE PREFERRED EMBODIMENTS

The above and other technical details, features and effects of the present invention will be better understood with regard to the detailed description of the embodiments below, with reference to the drawings.

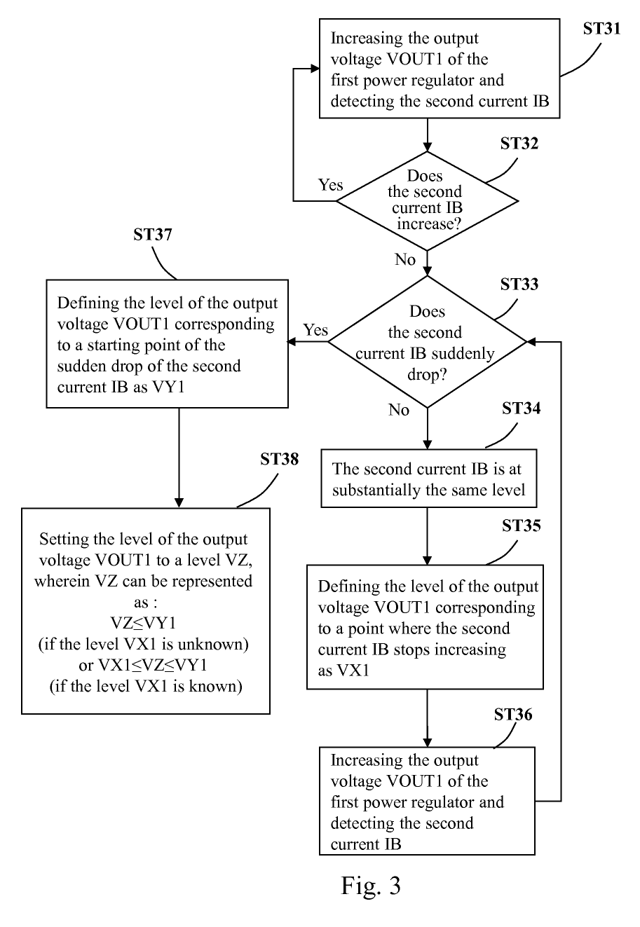

Please refer to FIG. 2. FIG. 2 shows a block diagram, illustrating an embodiment of a hardware configuration where a control method for supplying power according to the present invention can be applied to. The hardware configuration 20 of this embodiment comprises a first power regulator 21 and an electronic system 22. The electronic system 22 comprises a second power regulator 221 and a load 222. As shown in FIG. 2, the second power regulator 221 is coupled between the first power regulator 21 and the load 222. The electronic system 22 of this embodiment can be, for example but not limited to, a cellular phone, a laptop computer or a tablet computer. The second power regulator 221 can be, for example but not limited to, a battery charger. Such battery charger can be, for example but not limited to, a linear regulator or a switching regulator. The load 222 can be, for example but not limited to, a circuit in the electronic system 22 or a rechargeable battery in the electronic system 22. The external power source can be, for example but not limited to, a public AC power. And, correspondingly, the first power regulator 21 can be, for example but not limited to, an AC/DC adaptor.

As shown in FIG. 2, when the external power source is coupled to the first power regulator 21, the first power regulator 21 accordingly receives an AC voltage and an alternating current AC current from the external power source and outputs an output voltage VOUT1 (which is a DC voltage) and a first current IA (which is a DC current). That is, the external power source supplies the first current IA to the electronic system 22 through the first power regulator 21. The first current IA is converted to a second current IB by the second power regulator 221, and the second power regulator 221 supplies the second current IB to the load 222.

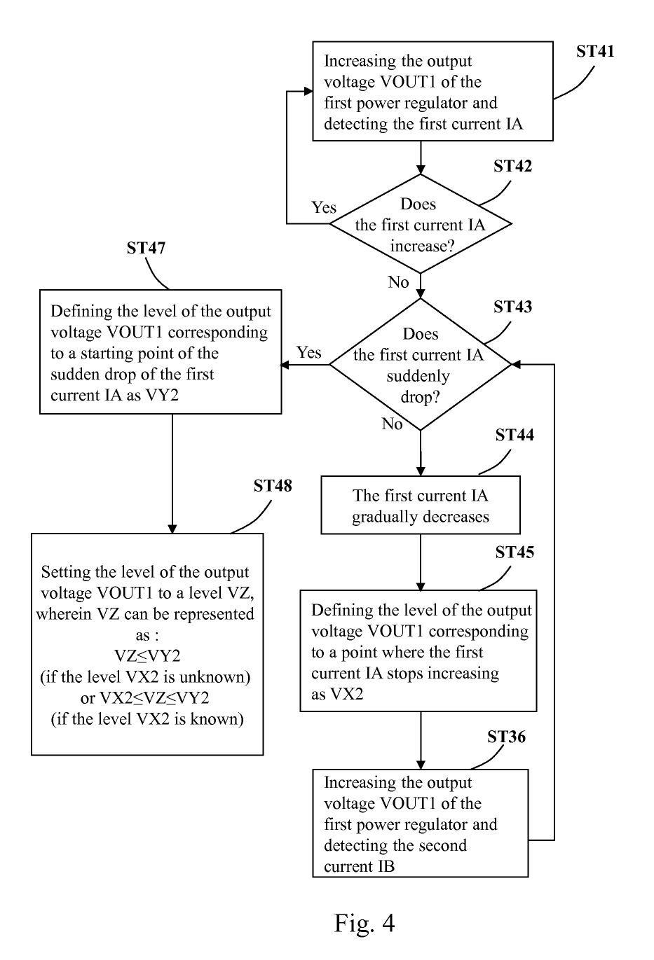

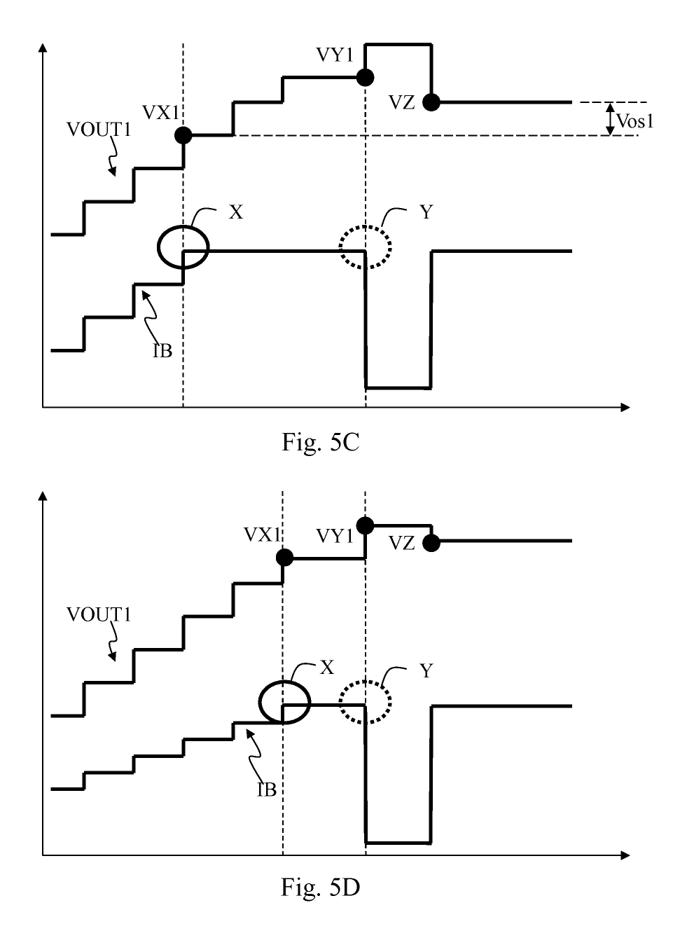

Please refer to FIG. 3 in conjugation with FIGS. 5A-5D. FIG. 3 shows a flowchart, illustrating an embodiment of the control method for supplying power according to the present invention. FIGS. 5A-5D show, according to the control method for supplying power shown in FIG. 3, diagrams illustrating relationships between the second current IB and the output voltage VOUT1. In this embodiment, the present invention finds an optimal level VZ of the output voltage VOUT1 according to the second current IB, so that a power supply efficiency to the load 222 is optimal. That is, the load 222 is supplied with the second current IB as largest as possible, but the amount of the supplied second current IB will not exceed a maximum current limit that the load 222 can receive (e.g., an over current protection limit). For example, when the load 222 is a battery, this optimal power supply efficiency can charge the battery in a shortest time.

First, the hardware configuration 20 of this embodiment increases the output voltage VOUT1 and detects the second current IB. The output voltage VOUT1 can be increased continuously (as shown in FIGS. 5A-5B), or discontinuously (e.g., in a stepwise manner, wherein the intervals between the steps can be the same or different, as shown in FIGS. 5C-5D), or by any other approach (e.g., a combination of the continuous increase and the discontinuous increase). Because the input power of the second power regulator 221 increases, the output power of the second power regulator 221 correspondingly increases. Therefore, if the maximum current limit of the load 222 is not reached, the second current IB will keep increasing as the level of the output voltage VOUT1 increases, as shown at the left side of FIGS. 5A-5D (step ST31 of FIG. 3).

Next, it is determined whether the second current IB increases as the output voltage VOUT1 increases (step ST32). If it is determined yes, the process flow returns to step ST31 and keeps increasing the output voltage VOUT1. If it is determined no, the process flow proceeds to step ST33 to determine whether the second current IB suddenly drops. The present invention delicately takes advantage of a protection mechanism normally existing in the electronic system 22. That is, if the current supplied to the load 222 reaches the maximum current limit of the load 222, this will trigger the protection mechanism of the electronic system 22 to prevent the load 222 from receiving any more current, and under such circumstance, the second current IB will suddenly drop (referring to FIGS. 5A-5D). As to how to determine whether the second current IB “suddenly drops”, in one embodiment, a reference current level can be set, and if the second current IB is lower than this reference current level, it is an indication that the second current IB is “suddenly dropping”. Or, in another embodiment, a reference dropping speed can be set, and if the second current IB drops by a speed larger than this reference dropping speed, it is an indication that the second current IB is “suddenly dropping”.

If it is determined no in step ST33, it indicates that the second current IB neither increases nor suddenly drops, and thus the second current IB can be defined as “substantially at the same level” (step ST34). Next, the process flow proceeds to step ST35, in which the level of the output voltage VOUT1 which corresponds to a point where the second current IB stops increasing (as shown by the threshold point X in FIGS. 5A, 5C and 5D) is defined as a level VX1 of the output voltage VOUT1. Next, the process flow can either return to step ST31 or proceed to step ST36 to keep increasing the level of the output voltage VOUT1. Subsequent to step ST36, the process flow proceeds to step ST33 to determine whether the second current IB suddenly drops.

If it is determined yes in step ST33 (regardless whether the level VX1 of the output voltage VOUT1 is defined or not), the process flow proceeds to step ST37, in which the level of the output voltage VOUT1 which corresponds to a starting point (as shown by the threshold point Y in FIGS. 5A-5D) of the sudden drop of the second current IB is defined as a level VY1 of the output voltage VOUT1. Subsequent to step ST37, the process flow proceeds to step ST38 to set the output voltage VOUT1 to a level VZ, wherein the relationship among the level VZ, the level VX1 and the level VY1 can be represented as: VZ≦VY1 (if the level VX1 is unknown) or VX1≦VZ≦VY1 (if the level VX1 is known).

The level VZ obtained according to the above steps is an optimal level of the output voltage VOUT1 whereby the load 222 can be supplied with a current as largest as possible, while the current will not exceed the maximum current limit of the load 222.

Ideally, on one hand, when the level VX1 of the output voltage VOUT1 is known, because the second current IB corresponding to the level VX1 of the output voltage VOUT1 is approximately equal to a maximum current that the load 222 can receive, it is optimal to set the level VZ of the output voltage VOUT1 to this level VX1, for best power supply efficiency under lowest power consumption. On the other hand, when the level VX1 of the output voltage VOUT1 can not be known but only the level VY1 of the output voltage VOUT1 is known, because the second current IB corresponding to the level VY1 of the output voltage VOUT1 is approximately equal to a maximum current that the load 222 can receive, the level VZ of the output voltage VOUT1 can be set to this level VY1, for best power supply efficiency. However, in practical situation, due to inaccuracy in manufacture and characteristics measurements of the devices of the circuits, in one embodiment, the level VZ of the output voltage VOUT1 is preferably set as follows:

(1) when the level VX1 of the output voltage VOUT1 is known, the level VZ is set to the level VX1 plus a first safety offset Vos1;

(2) when the level VX1 of the output voltage VOUT1 is unknown but only the level VY1 of the output voltage VOUT1 is known, the level VZ is set to the level VY1 minus a second safety offset Vos2 (referring to FIGS. 5A-5D).

Certainly, it should be understood that above arrangements are only illustrative examples, but not for limiting the scope of the present invention. It is also practicable and within the scope of the present invention as long as the level VZ, the level VX1 and the level VY1 can satisfy the relationship: VZ≦VY1 (if the level VX1 is unknown) or VX1≦VZ≦VY1 (if the level VX1 is known).

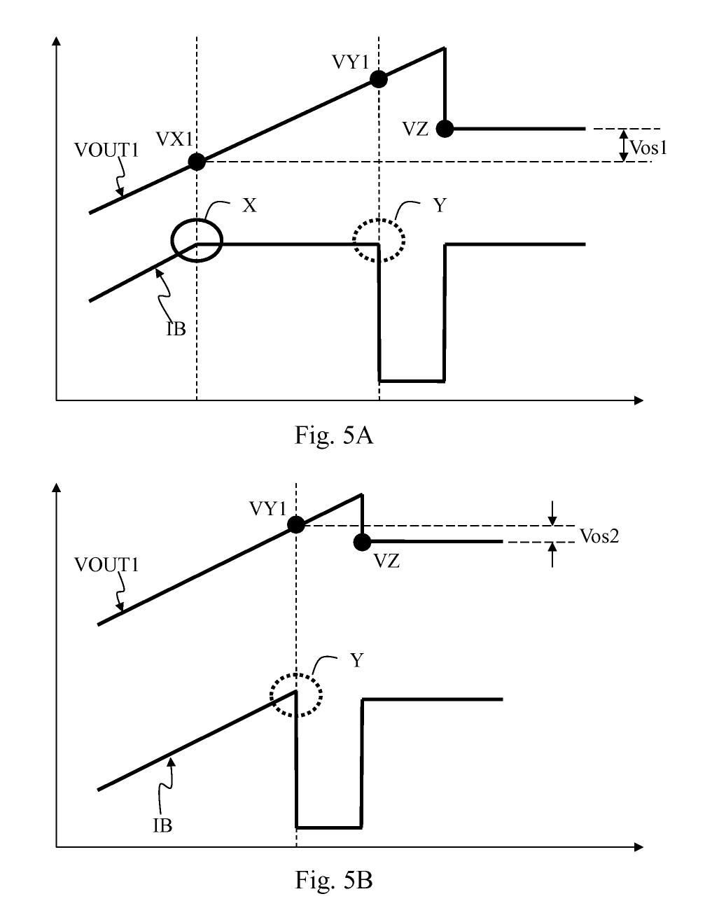

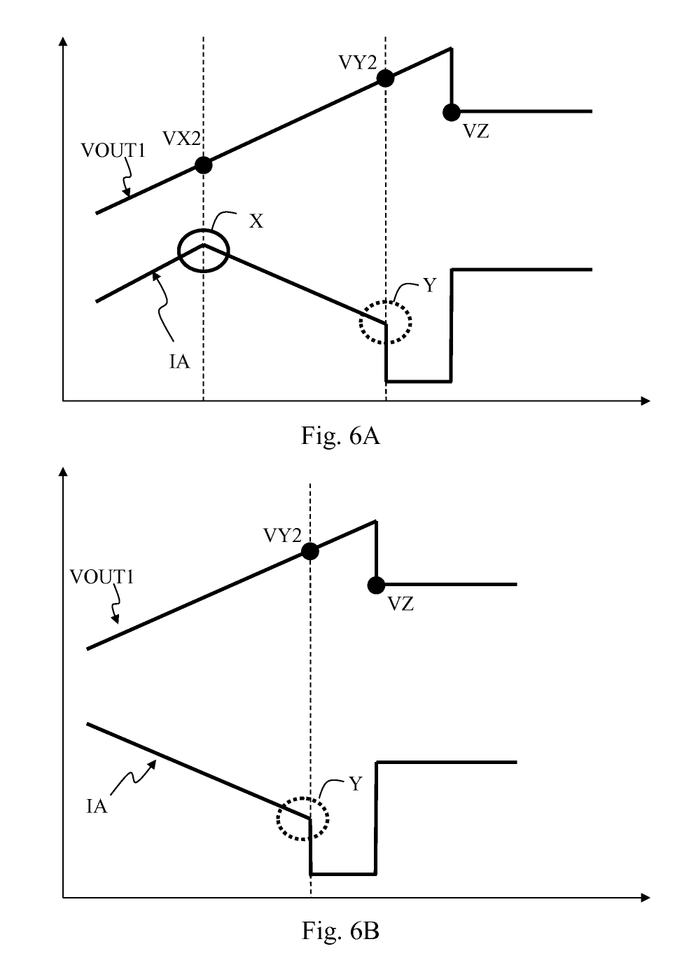

Please refer to FIG. 4 in conjugation with FIGS. 6A-6B. FIG. 4 shows a flowchart, illustrating another embodiment of the control method for supplying power according to the present invention. FIGS. 6A-6B show, according to the control method for supplying power shown in FIG. 4, diagrams illustrating relationships between the first current IA and the output voltage VOUT1. In this embodiment, the present invention finds an optimal level VZ of the output voltage VOUT1 according to the first current IA, so that a power supply efficiency to the load 222 is optimal.

First, the hardware configuration 20 of this embodiment increases the output voltage VOUT1 and detects the first current IA (step ST41). The output voltage VOUT1 can be increased continuously, discontinuously, or by any other approach (e.g., a combination of the continuous increase and the discontinuous increase), as explained in the foregoing embodiments. For simplicity, the following description only takes the continuous increase as an example. Referring to FIG. 6A, when the output power of the first power regulator 21 has not yet reached a maximum output power, the first current IA increases as the output voltage VOUT1 increases (as shown by the left side of the threshold point X in FIG. 6A). However, when the output power of the first power regulator 21 has reached a maximum output power, the first current IA decreases as the output voltage VOUT1 increases (as shown by the region between the threshold point X and the threshold point Y in FIG. 6A). Or, referring to FIG. 6B, if the first power regulator 21 already outputs its maximum output power at the very beginning of the operation, the first current IA decreases as the output voltage VOUT1 increases (as shown by the left side of the threshold point Y in FIG. 6B).

Next, it is determined whether the first current IA increases as the output voltage VOUT1 increases (step ST42). If it is determined yes, the process flow returns to step ST41 to keep increasing the output voltage VOUT1. If it is determined no, the process flow proceeds to step ST43 to determine whether the first current IA suddenly drops. Please refer to FIGS. 6A-6B. In the region between the threshold point X and the threshold point Y as shown in FIG. 6A, or, at left side of the threshold point Y as shown in FIG. 6B, the first current IA “gradually decreases”. However, after the first current IA reaches the threshold point Y, the first current IA “suddenly drops”. As to how to differentiate “gradually decrease” from “sudden drop”, in one embodiment, a reference current level can be set for the first current IA; when the first current IA is lower than this reference current level, it is an indication that the first current IA is “suddenly dropping”. Or, in another embodiment, a reference dropping speed can be set, and if the first current IA drops by a speed larger than this reference dropping speed, it is an indication that the first current IA is “suddenly dropping”. The level of this reference dropping speed level can be set between the speed of “gradually decrease” and the speed of “sudden drop”.

If it is determined no in step ST43, it indicates that the first current IA neither increases nor suddenly drops, and thus the first current IA can be defined as “gradually decreasing” (step ST44). Next, the process flow proceeds to step ST45, in which the level of the output voltage VOUT1 which corresponds to a point where the first current IA stops increasing (as shown by the threshold point X in FIG. 6A) is defined as a level VX2 of the output voltage VOUT1. Next, the process flow can either return to step ST41 or proceed to step ST46 to keep increasing the output voltage VOUT1. Subsequent to step ST46, the process flow proceeds to step ST43 to determine whether the first current IA suddenly drops.

If it is determined yes in step ST43 (regardless whether the level VX2 of the output voltage VOUT1 is defined or not), the process flow proceeds to step ST47, in which the level of the output voltage VOUT1 which corresponds to a starting point (as shown by the threshold point Y in FIGS. 6A-6B) of the sudden drop of the first current IA is defined as a level VY2 of the output voltage VOUT1. Subsequent to step ST47, the process flow proceeds to step ST48 to set the level of the output voltage VOUT1 to a level VZ, wherein the relationship among the level VZ, the level VX2 and the level VY2 can be represented as: VZ≦VY2 (if the level VX2 is unknown) or VX2≦VZ≦VY2 (if the level VX2 is known).

The level VZ obtained according to the above steps is an optimal level of the output voltage VOUT1 whereby the load 222 can be supplied with a current as largest as possible, while the current will not exceed the maximum current limit of the load 222.

Certainly, similar to the previous embodiments, the level VZ can be set to be equal to the level VX2 plus a safety offset or the level VY2 minus a safety offset.

Note that the above-mentioned method for detecting the first current IA and the above-mentioned method for detecting the second current IB can be combined together, so as to set the level VZ of the output voltage VOUT1 as follow:

(1) if neither VX1 nor VX2 is known, the level VZ can be set as: VZ≦(a lower one of VY1 and VY2);

(2) if only one of VX1 or VX2 is known, the level VZ can be set as: (the one of VX1 or VX2 which is known)≦VZ≦(a lower one of VY1 and VY2);

(3) if both VX1 and VX2 are known, the level VZ can be set as: (a higher one of VX1 and VX2)≦VZ≦(a lower one of VY1 and VY2).

It should be noted that the present invention is not limited to the aforesaid sequence of the steps; while the steps are described in certain order with regard to FIGS. 3 and 4, the sequence of the steps can be varied in other embodiments, and non-dependent steps can be implemented in parallel.

The present invention has been described in considerable detail with reference to certain preferred embodiments thereof. It should be understood that the description is for illustrative purpose, not for limiting the scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, the external power source is not limited to an AC power source, and the first power regulator 21 is not limited to be an AC/DC converter which converting an AC power to a DC power. That is, the external power source can be a DC power source and the first power regulator 21 can be a DC/DC converter. In view of the foregoing, the spirit of the present invention should cover all such and other modifications and variations, which should be interpreted to fall within the scope of the following claims and their equivalents.

What is claimed is:

1. A control method for supplying power to an electronic system through a first power regulator, wherein the first power regulator supplies a first current and an output voltage to the electronic system and the electronic system includes a second power regulator and a load, the second power regulator being coupled between the first power regulator and the load, and the second power regulator receiving the first current and supplying a second current to the load; the control method for supplying power comprising the steps of:
increasing the output voltage and detecting the second current;
determining whether the second current suddenly drops as the output voltage increases;
when the second current suddenly drops, defining a level of the output voltage which corresponds to a starting point of the sudden drop of the second current as a first upper limit; and
setting the output voltage to be lower than or equal to the first upper limit.

2. The control method for supplying power of claim 1, further comprising:
when the output voltage increases but the second current neither increases nor suddenly drops, defining a level of the output voltage which corresponds to a point where the second current stops increasing as a first lower limit; and
setting the output voltage to be lower than or equal to the first upper limit, and higher than or equal to the first lower limit.

3. The control method for supplying power of claim 1, further comprising:
when the second current increases as the output voltage increases, keeping increasing the output voltage.

4. The control method for supplying power of claim 1, further comprising:
increasing the output voltage and detecting the first current;
determining whether the first current suddenly drops as the output voltage increases;
when the first current suddenly drops, defining a level of the output voltage which corresponds to a starting point of the sudden drop of the first current as a second upper limit; and
setting the output voltage to be lower than or equal to a lower one of the first upper limit and the second upper limit.

5. The control method for supplying power of claim 4, further comprising:
when the output voltage increases but the first current neither increases nor suddenly drops, defining a level of the output voltage which corresponds to a point where the first current stops increasing as a lower limit; and
setting the output voltage to be lower than or equal to the lower one of the first upper limit and the second upper limit, and higher than or equal to the lower limit.

6. The control method for supplying power of claim 2, further comprising:
increasing the output voltage and detecting the first current;
determining whether the first current suddenly drops as the output voltage increases;
when the first current suddenly drops, defining a level of the output voltage which corresponds to a starting point of the sudden drop of the first current as a second upper limit; and
setting the output voltage to be lower than or equal to a lower one of the first upper limit and the second upper limit, and higher than or equal to the first lower limit.

7. The control method for supplying power of claim 6, further comprising:
when the output voltage increases but the first current neither increases nor suddenly drops, defining a level of the output voltage which corresponds to a point where the first current stops increasing as a second lower limit; and
setting the output voltage to be lower than or equal to the lower one of the first upper limit and the second upper limit, and higher than or equal to a higher one of the first lower limit and the second lower limit.

8. The control method for supplying power of claim 1, wherein the first power regulator is an AC/DC adaptor and the load is a rechargeable battery.

9. A control method for supplying power to an electronic system through a first power regulator, wherein the first power regulator supplies a first current and an output voltage to the electronic system and the electronic system includes a second power regulator and a load, the second power regulator being coupled between the first power regulator and the load, and the second power regulator receiving the first current and supplying a second current to the load; the control method for supplying power comprising the steps of:
increasing the output voltage and detecting the first current;
determining whether the first current suddenly drops as the output voltage increases;
when the first current suddenly drops, defining a level of the output voltage which corresponds to a starting point of the sudden drop of the first current as an upper limit; and
setting the output voltage to be lower than or equal to the upper limit.

10. The control method for supplying power of claim 9, further comprising:
when the output voltage increases but the first current neither increases nor suddenly drops, defining a level of the output voltage which corresponds to a point where the first current stops increasing as a lower limit; and
setting the output voltage to be lower than or equal to the upper limit, and higher than or equal to the lower limit.

11. The control method for supplying power of claim 9, wherein the first power regulator is an AC/DC adaptor and the load is a rechargeable battery.
